(19) United States
(12) Patent Application Publication
(10) Pub. No.: US 2009/0225843 A1
(43) Pub. Date: Sep. 10, 2009

(54) METHOD AND APPARATUS FOR ENCODING AND DECODING IMAGE

(75) Inventors: Jae-chool Lee, Suwon-si (KR); Min-su Cheon, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/398,246

(22) Filed: Mar. 5, 2009

(30) Foreign Application Priority Data
Mar. 5, 2008 (KR) 10-2008-0020587

(51) Int. Cl. H04N 7/26; H04N 7/32

(52) U.S. Cl. 375/240.13; 375/240.12; 375/240.16; 375/E07.123; 375/E07.243

(57) ABSTRACT

Provided are a method and apparatus for encoding and decoding an image to reduce residual energy by using spatial residual prediction of an inter-residual in an image codec system based on spatial and temporal prediction. The method includes generating a first residual signal corresponding to a difference between an original block image and a prediction block image, generating a second residual signal corresponding to a difference between a reconstructed neighboring block image of a current block and the prediction block image, and predicting the first residual signal based on the second residual signal.

### CROSS-REFERENCE TO RELATED PATENT APPLICATION

This application claims priority from Korean Patent Application No. 10-2008-0020587, filed on Mar. 5, 2008 in the Korean Intellectual Property Office, the disclosure of which is incorporated herein in its entirety by reference.

### BACKGROUND OF THE INVENTION

1. Field of the Invention

Methods and apparatuses consistent with the present invention generally relate to encoding and decoding an image, and more particularly, to encoding and decoding an image, whereby residual energy can be reduced by using spatial residual prediction of an inter-residual in an image codec system based on spatial and temporal prediction.

2. Description of the Related Art

Generally, the H.264/Moving Picture Experts Group (MPEG)-4 Advanced Video Coding (AVC) image compression standard uses various techniques such as multiple reference motion compensation, loop filtering, variable block size motion compensation, and entropy coding like context-adaptive binary arithmetic coding (CABAC) to improve compression efficiency,

According to the H.264 standard, encoding and decoding are performed in units of a plurality of macroblocks included in a single frame or sub-blocks obtained by halving or quartering a macroblock. After each of the macroblocks is encoded in all interprediction and intraprediction encoding modes, bit rates required for encoding the macroblock and rate-distortion (RD) costs between the original block and an encoded block for the encoding modes are compared. Then an optimal encoding mode is selected according to the results of the comparison and the macroblock is encoded in the selected encoding mode. Interprediction involves predicting a motion of a macroblock of a current frame with reference to a macroblock of a neighboring frame and intraprediction involves predicting a motion of a macroblock of a current frame by using a neighboring macroblock within the current frame.

A prediction block for a current block to be encoded using interprediction or intraprediction is generated and only a residual block obtained by subtracting the prediction block from the current block is encoded.

In order to efficiently code a high-definition image, the energy of a residual (or a prediction error) has to be reduced.

However, in a residual signal between inter-frames from which temporal redundancy is removed, a spatial residual pattern exists. For example, focus and capture time noise of a camera has a spatial feature. The spatial residual pattern increases residual energy during video coding.

Therefore, for efficient high-definition video coding, there is a need for a processor for reducing temporal residual energy in a residual signal between inter-frames.

### SUMMARY OF THE INVENTION

The present invention provides a method of encoding and decoding an image, whereby residual energy can be reduced by predicting a current residual block by using spatial correlation of an inter-residual.

The present invention also provides an apparatus for encoding and decoding an image, whereby residual energy can be reduced by predicting a current residual block by using spatial correlation of an inter-residual.

According to an aspect of the present invention, there is provided a method of encoding an image. The method includes generating a first residual signal corresponding to a difference between an original block image and a prediction block image, generating a second residual signal corresponding to a difference between a reconstructed neighboring block image of a current block and the prediction block image, and predicting the first residual signal based on the second residual signal.

According to another aspect of the present invention, there is provided a method of decoding an image. The method includes entropy-decoding a bitstream in order to decode a residual signal and performing spatial residual prediction on the decoded residual signal based on a first residual signal corresponding to a difference between a reconstructed neighboring block of a current block and a prediction block of the current block, in order to decode a second residual signal corresponding to a difference between an original block image and a prediction block image.

According to another aspect of the present invention, there is provided an apparatus for encoding an image. The apparatus includes a prediction unit generating a prediction block of a current block to be encoded based on interprediction or intraprediction, a first subtraction unit generating a first residual signal corresponding to a difference between an original block image and a prediction block image, a second subtraction unit generating a second residual signal corresponding to a difference between a reconstructed block image of a current block and the prediction block image, and a spatial residual prediction unit predicting the first residual signal based on the second residual signal.

According to another aspect of the present invention, there is provided an apparatus for decoding an image. The apparatus includes an entropy-decoding unit entropy-decoding a bitstream in order to decode a residual signal and a spatial residual prediction processing unit performing spatial residual prediction on the decoded residual signal based on a first residual signal corresponding to a difference between a reconstructed neighboring block of a current block and a prediction block of the current block, in order to decode a second residual signal corresponding to a difference between an original block image and a prediction block image.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a spatial residual prediction processing unit applied to an image encoding/decoding system according to an exemplary embodiment of the present invention;

FIG. 2 is a block diagram of an apparatus for encoding an image using a method of encoding an image according to an exemplary embodiment of the present invention;

FIG. 3 is a detailed flowchart of operations performed by the spatial residual prediction processing unit illustrated in FIG. 2, according to an exemplary embodiment of the present invention;

FIGS. 4A, 4B and 4C are flowcharts of an operation of predicting a first residual signal illustrated in FIG. 3 according to various exemplary embodiments of the present invention;

FIG. 5 is a block diagram of an apparatus for decoding an image using a method of decoding an image according to an exemplary embodiment of the present invention; and

FIG. 6 is a detailed flowchart of operations performed by a spatial residual prediction processing unit illustrated in FIG. 5, according to an exemplary embodiment of the present invention.

### DETAILED DESCRIPTION OF EXEMPLARY EMBODIMENTS OF THE INVENTION

Hereinafter, exemplary embodiments of the present invention will be described in detail with reference to the accompanying drawings. It should be noted that like reference numerals refer to like elements illustrated in one or more of the drawings. In the following description of the present invention, detailed description of known functions and configurations incorporated herein will be omitted for conciseness and clarity.

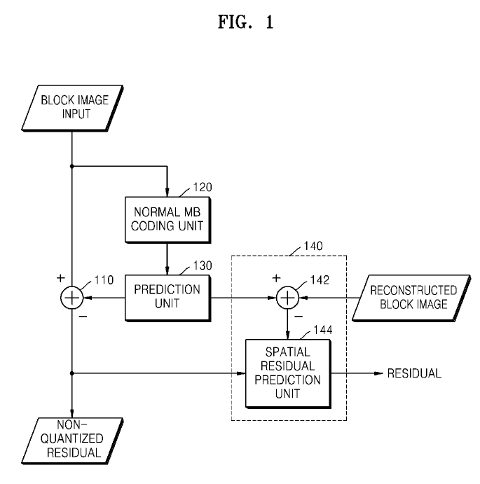

FIG. 1 is a block diagram of a spatial residual prediction processing unit applied to an image encoding/decoding system according to an exemplary embodiment of the present invention.

Generally, a residual image between inter-frames may include a portion having large residual energy or a pattern portion having constant residual energy. In that portion, adjacent residual macroblocks have similar pattern characteristics. The present invention suggests a way to reduce residual energy (or a prediction error) by using spatial correlation of the residual image.

Referring to FIG. 1, the spatial residual prediction processing unit includes a first subtraction unit 110, a normal macroblock (MB) coding unit 120, a prediction unit 130, and a spatial residual prediction execution unit 140. The spatial residual prediction execution unit 140 includes a second subtraction unit 142 and a spatial residual prediction unit 144.

The normal macroblock coding unit 120 codes a macroblock-based image in units of macroblocks by using an image compression standard algorithm.

The prediction unit 130 generates a prediction block for a current block to be encoded by using interprediction or intraprediction.

The first subtraction unit 110 generates a first residual signal corresponding to a difference between an original block image and a prediction block image. The first residual signal is a non-quantized signal.

The second subtraction unit 142 generates a second residual signal corresponding to a difference between an image of a neighboring block (or a neighboring block image) of the current block within a currently coded frame and the prediction block generated by the prediction unit 130. The second residual signal is a residual signal of a quantized neighboring block.

The spatial residual prediction unit 144 performs prediction on the first residual signal generated by the first subtraction unit 110 based on the second residual signal generated by the second subtraction unit 142. The spatial residual prediction unit 144 may use spatial correlation of a residual image.

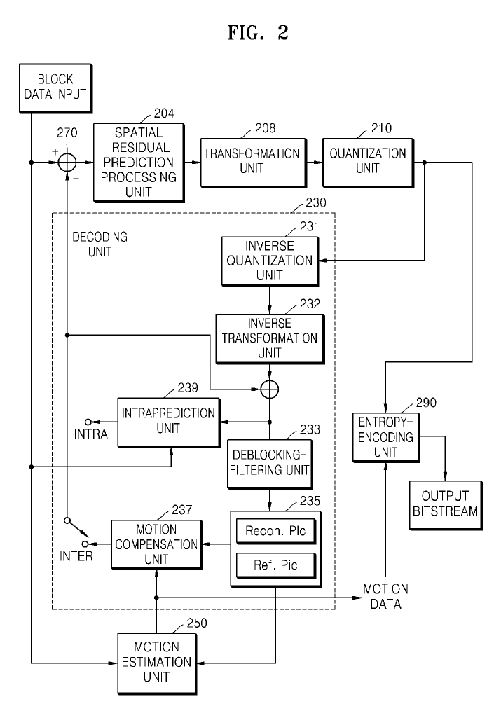

FIG. 2 is a block diagram of an apparatus for encoding an image, to which a method of encoding an image according to an exemplary embodiment of the present invention.

Referring to FIG. 2, the apparatus for encoding an image according to the current exemplary embodiment includes a spatial residual prediction processing unit 204, a transformation unit 208, a quantization unit 210, a decoding unit 230 including an inverse quantization unit 231, an inverse transformation unit 232, a deblocking-filtering unit 233, a picture reconstruction unit 235, a motion compensation unit 237, and an intraprediction unit 239, a motion estimation unit 250, a subtraction unit 270, and an entropy-encoding unit 290.

First, image data is input to the apparatus illustrated in FIG. 2 in units of macroblocks composed of 16×16 pixels.

The spatial residual prediction processing unit 204 generates a residual signal corresponding to a difference between a reconstructed neighboring block image of the current block and a prediction block image, and predicts a spatial residual signal for a current residual signal generated by the subtraction unit 270 by using the generated residual signal. At this time, the prediction of the spatial residual signal (or spatial residual prediction) may be performed by using various prediction algorithms such as an intraprediction mode, a block pattern, or a block search.

The transformation unit 208 transforms the spatial residual signal predicted by the spatial residual prediction processing unit 204 according to a predetermined transformation scheme. A representative transformation scheme may be, for example, discrete cosine transformation.

The quantization unit 210 receives and quantizes the spatial residual signal transformed by the transformation unit 208 according to the predetermined transformation scheme.

The inverse quantization unit 231 receives and inversely quantizes quantized residual information output from the quantization unit 210.

The inverse transformation unit 232 inversely transforms the inversely-quantized residual information output from the inverse quantization unit 231.

The deblocking-filtering unit 233 receives the inversely-transformed residual information from the inverse transformation unit 232 and performs filtering on the received residual information to remove a blocking effect.

The picture reconstruction unit 235 receives the filtered residual information from the deblocking-filtering unit 233 for reconstruction of a picture-based image. The picture-based image is a frame-based image or a field-based image. The picture reconstruction unit 235 may include a frame memory (not shown) capable of storing a plurality of pictures which are reference pictures provided for motion estimation.

The motion estimation unit 250 performs motion estimation by searching for a region that is most similar to the current macroblock in an image of a reference frame stored in the frame memory of the picture reconstruction unit 235. More specifically, the motion estimation unit 250 searches a predetermined range (search range) of the reference frame, which extends from a position of the current macroblock, and selects a region having the smallest difference from the current macroblock within the search range as the most similar region. The motion estimation unit 250 outputs a spatial position difference between the selected region and the current macroblock as a motion vector.

The motion compensation unit 237 reads the region that is most similar to the current macroblock from the image of the reference frame stored in the frame memory by using the motion vector and generates an interpredicted prediction block. The motion estimation unit 250 and the motion compensation unit 237 interact with each other, thereby forming an interprediction unit for performing interprediction.

The intraprediction unit 239 performs intraprediction by searching in a current picture for a prediction value of the current block.

Interprediction and intraprediction may be performed in units of not only 16×16 macroblocks but also 16×8, 8×16, 8×8, 8×4, 4×8, or 4×4 blocks.

Once the prediction block for the current block to be encoded is formed through interprediction or intraprediction, the subtraction unit 270 calculates a difference between the current block and the prediction block in order to output a residual signal.

The residual signal output from the subtraction unit 270 is transformed and quantized by the spatial residual prediction processing unit 204, the transformation unit 208, and the quantization unit 210, and the quantized residual signal is entropy-encoded by the entropy-encoding unit 290 and then output as a bitstream. In this regard, the bitstream includes residual data, intraprediction mode information, and motion information.

The decoding unit 230 decodes the bitstream generated by the apparatus for encoding an image according to the current exemplary embodiment of the present invention

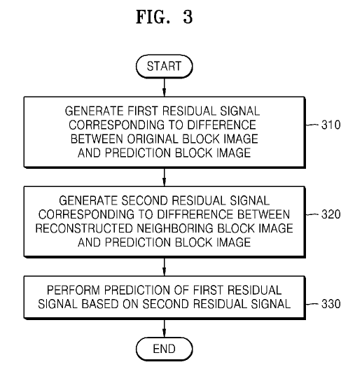

FIG. 3 is a detailed flowchart of operations performed by the spatial residual prediction processing unit 204 illustrated in FIG. 2, according to an exemplary embodiment of the present invention.

In operation 310, a first residual signal corresponding to a difference between an original block image and a prediction block image is generated.

In operation 320, a second residual signal corresponding to a difference between a reconstructed neighboring block image of a current block and the prediction block image is generated.

Prediction of the first residual signal (or spatial residual prediction) is performed based on the second residual signal in order to generate a spatial residual prediction signal in operation 330. The spatial residual prediction may be performed by using various algorithms such as an intraprediction mode, a block pattern, or a block search.

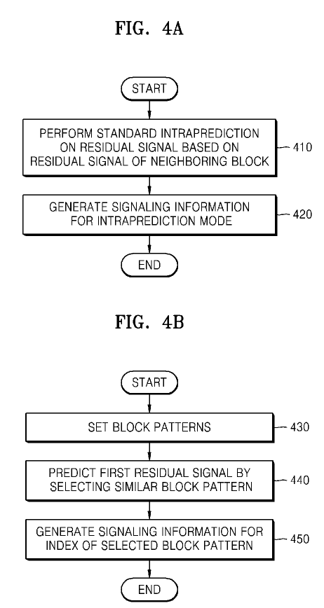

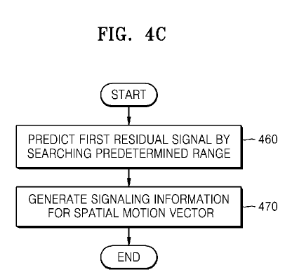

FIGS. 4A, 4B and 4C are flowcharts of an operation of predicting the first residual signal illustrated in FIG. 3 according to various exemplary embodiments of the present invention.

FIG. 4A is a flowchart of spatial residual prediction using an intraprediction mode, according to an exemplary embodiment of the present invention.

In operation 410, 4×4 intraprediction, 8×8 intraprediction, and 16×16 intraprediction, defined as standards of conventional H.264, are performed by using a residual signal (i.e., the second residual signal) of a neighboring block of a block to be encoded. Thus, prediction of the first residual signal is performed by conventional intraprediction. At this time, the neighboring block is an image signal that has already been encoded.

For example, in 4×4 intraprediction, a prediction block is generated by using neighboring pixels of a current block, a sum of absolute differences (SAD) between the prediction block and the original block is obtained, and a mode having a smallest SAD is selected as an optimal prediction mode from among nine modes.

In operation 420, signaling information for an intraprediction mode used in the spatial residual prediction is generated. At this time, low-frequency components have been removed from residual blocks. Thus, intraprediction for the spatial residual prediction does not require an intraprediction mode such as a DC prediction mode, thereby reducing additional signaling bits.

According to another exemplary embodiment of the present invention, an intraprediction mode of the first residual signal may be estimated by referring to a prediction direction of a residual signal (the second residual signal) of a neighboring block of a current block to be encoded. For example, if previously-encoded neighboring blocks are dominant in a horizontal direction, the horizontal direction is estimated as the intraprediction mode.

FIG. 4B is a flowchart of spatial residual prediction using a block pattern, according to another exemplary embodiment of the present invention.

In operation 430, a plurality of block patterns are set.

In operation 440, a first residual signal is predicted by selecting a block pattern that is similar to the first residual signal from among the plurality of block patterns. Differential pulse coded modulation data corresponding to an encoded difference between the selected block pattern and the first residual signal is transmitted to an image decoding unit during bitstream transmission.

In operation 450, signaling information for an index of the selected block pattern is generated.

According to another exemplary embodiment of the present invention, a block pattern for the first residual signal may be estimated by combining patterns of residual signals of neighboring blocks of a current block to be encoded. For example, if most of the residual signals of the neighboring blocks have a vertical pattern, the block pattern for the first residual signal may be estimated as a vertical block pattern.

FIG. 4C is a flowchart of spatial residual prediction using a block search, according to another exemplary embodiment of the present invention.

In operation 460, a first residual block (or signal) is predicted by searching a predetermined range of second residual blocks of neighboring blocks of a current block to be encoded, i.e., by a residual block search. The predetermined range extends from a position of the first residual block. In other words, a second residual block that is most similar to the first residual block is determined as the current residual block to be predicted.

Difference information between the similar residual block and the current residual block is generated by the residual block search.

In operation 470, signaling information for a spatial motion vector obtained by the residual block search is generated.

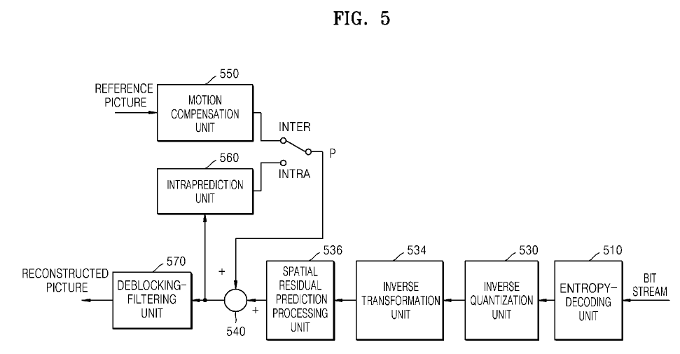

FIG. 5 is a block diagram of an apparatus for decoding an image using a method of decoding an image according to an exemplary embodiment of the present invention.

Referring to FIG. 5, the apparatus for decoding an image according to the current exemplary embodiment of the present invention includes an entropy-decoding unit 510, an inverse quantization unit 530, an inverse transformation unit 534, a spatial residual prediction processing unit 536, an addition unit 540, a motion compensation unit 550, an intraprediction unit 560, and a deblocking-filtering unit 570.

The entropy-decoding unit 510 entropy-decodes a bitstream in order to output a residual block. The entropy-decoding unit 510 may determine a mode in which the bitstream to be decoded has been encoded based on encoding information included in a header of the bitstream.

The inverse quantization unit 530 and the inverse transformation unit 534 perform inverse quantization and inverse transformation on the residual block output by the entropy-decoding unit 510 and encoding information in order to extract residual blocks, motion vector information, header information, and intraprediction mode information.

The spatial residual prediction processing unit 536 performs spatial residual prediction for the inversely transformed residual blocks output by the inverse transformation unit 534 based on a first residual signal corresponding to a difference between a reconstructed neighboring block of a current block and a prediction block, in order to decode a residual signal corresponding to a difference between an original block image and a prediction block image.

The motion compensation unit 550 and the intraprediction unit 560 generate a prediction block according to an encoded picture type by using decoded header information.

The addition unit 540 adds the prediction block generated by the motion compensation unit 550 and the intraprediction unit 560 to the residual block decoded by the spatial residual prediction processing unit 536, in order to generate a reconstructed image.

The deblocking-filtering unit 570 receives the reconstructed image and performs filtering to remove a blocking effect from the received image.

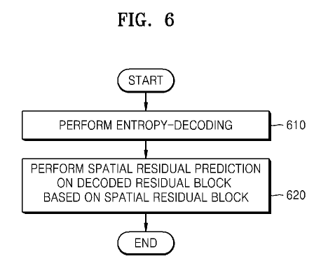

FIG. 6 is a detailed flowchart of operations performed by the spatial residual prediction processing unit 536 illustrated in FIG. 5, according to an exemplary embodiment of the present invention.

In operation 610, an encoded bitstream is received and is entropy-decoded to decode a residual block.

In operation 620, spatial residual prediction is performed on the decoded residual block based on a spatial residual block corresponding to a difference between a neighboring block of the decoded current block and a prediction block of the decoded current block, in order to decode a second residual signal corresponding to a difference between an original block image and a prediction block image.

The spatial residual prediction may be performed using various methods.

For example, a first residual block may be decoded by standard intraprediction based on decoded intraprediction mode information.

In another exemplary method, an intraprediction mode for the first residual block may be estimated by using a prediction direction used for a residual signal of a neighboring block of the decoded current block.

In another exemplary method, the first residual block may be decoded based on a block pattern corresponding to signaling information for an index of the block pattern.

In another exemplary method, a block pattern for the first residual block may be estimated by combining patterns of residual signals of neighboring blocks of a block to be decoded.

In another exemplary method, the first residual block may be decoded by performing a residual block search based on spatial motion vector information signaled in the bitstream.

At this time, if there is no spatial motion vector information in the bitstream, the first residual block may be decoded by blocking matching between a reference block and a current block.

As described above, according to the present invention, residual energy (or the amount of residual data) can be reduced by predicting a current residual block by using spatial correlation of an inter-residual in an image codec system. Therefore, high-definition video can be efficiently coded by reducing residual energy during encoding.

The present invention can be embodied as a computer-readable code on a computer-readable recording medium. The computer-readable recording medium is a data storage device that can store data which can be thereafter read by a computer system. Examples of computer-readable recording media include read-only memory (ROM), random-access memory (RAM), CD-ROMs, magnetic tapes, floppy disks, and optical data storage devices. The computer-readable recording medium can also be distributed over a network of coupled computer systems so that the computer-readable code is stored and executed in a decentralized fashion.

While the present invention has been particularly shown and described with reference to exemplary embodiments thereof, it will be understood by one of ordinary skill in the art that various changes in form and detail may be made therein without departing from the spirit and scope of the present invention as defined by the following claims.

What is claimed is:

1. A method of encoding an image, the method comprising:
generating a first residual signal corresponding to a difference between an original block image and a prediction block image;
generating a second residual signal corresponding to a difference between a reconstructed neighboring block image of a current block and the prediction block image; and
predicting the first residual signal based on the second residual signal.

2. The method of claim 1, wherein the predicting the first residual signal comprises:
predicting the first residual signal by performing intraprediction based on a residual signal of a neighboring block of the current block; and
generating signaling information for an intraprediction mode.

3. The method of claim 2, wherein the predicting the first residual signal comprises:
estimating an intraprediction mode based on a prediction direction of the residual signal of the neighboring block.

4. The method of claim 1, wherein the predicting the first residual signal comprises:
setting a plurality of block patterns;
predicting the first residual signal based on a block pattern among the block patterns that is most similar to the first residual signal; and
generating signaling information for an index of the most similar block pattern.

5. The method of claim 4, further comprising encoding a difference between the most similar block pattern signal and the first residual signal.

6. The method of claim 1, wherein the predicting the first residual signal comprises estimating block pattern for the first residual signal by combining patterns of the second residual signal.

7. The method of claim 1, wherein the predicting the first residual signal comprises:
predicting the first residual signal by searching a predetermined range of the second residual signal; and
generating signaling information for a spatial motion vector obtained through the searching.

8. The method of claim 7, further comprising generating difference information between a current residual block and a residual block that is most similar to the current residual block based on a result of the searching.

9. A method of decoding an image, the method comprising:
entropy-decoding a bitstream in order to decode a residual signal; and
performing spatial residual prediction on the decoded residual signal based on a first residual signal corresponding to a difference between a reconstructed neighboring block of a current block and a prediction block of the current block, in order to decode a second residual signal corresponding to a difference between an original block image and a prediction block image.

10. The method of claim 9, wherein the performing the spatial residual prediction comprises decoding the first residual signal by performing intraprediction based on an intraprediction mode signaled in the bitstream.

11. The method of claim 9, wherein the performing the spatial residual prediction comprises decoding the second residual signal by using intraprediction direction information signaled in the bitstream.

12. The method of claim 9, wherein the performing the spatial residual prediction comprises decoding the second residual signal based on an index for a block pattern signaled in the bitstream.

13. The method of claim 9, wherein the performing the spatial residual prediction comprises decoding the second residual signal based on spatial motion vector information signaled in the bitstream.

14. The method of claim 9, wherein the performing the spatial residual prediction comprises decoding the second residual signal by using block matching.

15. An apparatus for encoding an image, the apparatus comprising:
a prediction unit which generates a prediction block of a current block to be encoded based on interprediction or intraprediction;
a first subtraction unit which generates a first residual signal corresponding to a difference between an original block image and a prediction block image;
a second subtraction unit which generates a second residual signal corresponding to a difference between a reconstructed block image of a current block and the prediction block image; and
a spatial residual prediction unit which predicts the first residual signal generated by the first subtraction unit based on the second residual signal generated by the second subtraction unit.

16. The apparatus of claim 15, wherein the spatial residual prediction unit predicts the first residual signal by applying an intraprediction mode to the second residual signal.

17. The apparatus of claim 15, the spatial residual prediction unit predicts the first residual signal based on a block pattern that is similar to the first residual signal by using preset block patterns.

18. The apparatus of claim 15, the spatial residual prediction unit predicts the first residual signal based on a residual block search.

19. An apparatus for decoding an image, the apparatus comprising:
an entropy-decoding unit which entropy-decodes a bitstream in order to decode a residual signal; and
a spatial residual prediction processing unit which performs spatial residual prediction on the decoded residual signal based on a first residual signal corresponding to a difference between a reconstructed neighboring block of a current block and a prediction block of the current block, in order to decode a second residual signal corresponding to a difference between an original block image and a prediction block image.

20. The apparatus of claim 19, wherein the spatial residual prediction processing unit performs the spatial residual prediction on the decoded residual signal by referring to prediction information added to the residual signal.
